(19) United States
(12) Patent Application Publication
(10) Pub. No.: US 2023/0138410 A1
(43) Pub. Date: May 4, 2023

(54) ON-DEMAND ACTIVITY FEATURE GENERATION FOR MACHINE LEARNING MODELS

(71) Applicant: Microsoft Technology Licensing, LLC, Redmond, WA (US)

(72) Inventors: Benjamin H. LE, Santa Clara, CA (US); Qing LI, Fremont, CA (US); Rupesh GUPTA, Newark, CA (US); Alexander OVSIANKIN, Sunnyvale, CA (US); Minhtu A. Nguyen, San Jose, CA (US)

(21) Appl. No.: 17/515,457

(22) Filed: Oct. 30, 2021

(51) Int. Cl. G06N 5/02; G06N 5/04; G06F 16/248

(52) U.S. Cl. CPC G06N 5/022; G06N 5/04; G06F 16/248

(57) ABSTRACT

Technologies for generating user activity features for machine learning models on demand are described. In some embodiments, the technologies receive a request for a user activity feature and a request timestamp from a machine learning model. The technologies determine a data access mechanism, a time window determined based on the request timestamp, and a feature computation algorithm. Using the data access mechanism, the technologies retrieve, from a real-time data store, event data for events having timestamps within the time window, and attribute data associated with the event data. The technologies compute a user activity feature using the retrieved event data and the retrieved attribute data as inputs to the feature computation algorithm, and provide the computed user activity feature to the machine learning model in response to the request for the activity feature.

### TECHNICAL FIELD

A technical field to which the present disclosure relates is machine learning. Another technical field to which this disclosure relates is the training of machine learning models. Yet another technical field to which this disclosure relates is the generation of user activity features for the training and/or operation of machine learning models.

### BACKGROUND

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, a classification, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes an activity feature generation system in accordance with some embodiments of the present disclosure.

FIG. 2A is an example of an application system in communication with an activity feature generation system in accordance with some embodiments of the present disclosure.

FIG. 2B illustrates an example of an application system including a machine learning model in communication with an activity feature generation system in accordance with some embodiments of the present disclosure.

FIG. 2C is a flow diagram for activity feature generation in accordance with some embodiments of the present disclosure.

FIG. 2D is an example of a timeline for activity feature generation in accordance with some embodiments of the present disclosure.

FIG. 3 is a flow diagram of an example method to compute an activity feature for a machine learning model in accordance with some embodiments of the present disclosure.

FIG. 4A is an example of a data preparation system in accordance with some embodiments of the present disclosure.

FIG. 4B is a flow diagram of an example method to generate a recommendation set using computed activity features in accordance with some embodiments of the present disclosure.

FIG. 5 is a flow diagram of an example method to compute a feature for a machine learning model in accordance with some embodiments of the present disclosure.

FIG. 6 is a block diagram of an example computer system in which embodiments of the present disclosure can operate.

### DETAILED DESCRIPTION

User interface functionality of an application system is often supported by one or more recommendation systems. For example, a recommendation system can control the selection of digital content items to be displayed by the application system in a feed portion of a user interface, as well as the timing and order of occurrence of items in the feed. Another recommendation system can control the selection of suggested search terms to be displayed by the application system in a search portion of a user interface. Still other recommendation systems can control the selection of user profile records and/or job, organization, or product records to display a “people you may know,” “jobs you may be interested in,” “organizations you may be interested in,” or “products you may be interested in” section of the user interface.

These and other recommendation systems can be supported by machine learning models. A recommendation system can receive output of a machine learning model as an input, and use the machine learning model output to modify a previously generated recommendation or generate a new recommendation. For example, a machine learning model that has been trained on historical user activity data can, in response to newly received user activity data, produce model output that indicates a user intent or preference based on a degree of similarity or dissimilarity of the newly received user activity data to one or more of the historical user activity data on which the model has been trained.

Thus, machine learning model output can provide the recommendation system with an indication of the user's intent or preferences with respect to the newly received user activity data, relative to historical user activity data. The recommendation system can use the machine learning model output to, for example, sort, rank, group, or filter data records or digital content items that are candidates to be displayed in a user interface in a manner that is more closely aligned with the user's intent or preferences. Machine learning models that generate model output used to support recommendation systems can be referred to as relevance models, as the goal of the recommendation system often is to generate recommendations that are relevant to the user's intent or preferences.

The accuracy of the machine learning model output with respect to a newly received user activity can depend heavily on the recency of the historical activity data used to produce scores from the machine learning model. For example, if the historical user activity data captured in the recent past is missing, the machine learning model output may not accurately reflect the user's most current intent or preferences.

Due to the heavy computational burdens associated with the generation of features for machine learning models that support recommendation systems, feature generation and model training have been performed offline using batch processing. However, batch processing requires a time interval between batch processes that is typically much longer than the time between user activities in the application system.

For example, many users may typically interact with an application system at least daily, multiple times a day, or even multiple times in the same minute. One example of a common pattern of user activity is a search for people in the user's connections network who work at a certain company followed by a search on the company name, with the two searches separated by a matter of seconds to minutes or less. Another common pattern of user activity is a user viewing articles in the user's feed, followed by the user conducting a job search, with the two activities separated by a matter of seconds to minutes or less.

Unfortunately, batch processing is performed much less frequently; perhaps once a day. Thus, batch processing does not capture these and other types of context switches in user activity that occur within the same user session. As a result, other systems have been unable to incorporate very recent intra-session changes in user intents or preferences into the user activity feature generation processes.

Consequently, machine learning models that consume user activity features that have been pre-computed in batch processes can lack access to potentially very relevant recent user activity features. Downstream, this causes recommender systems to generate less than optimal recommendations because those recommendations are based on machine learning model outputs that have been produced without the benefit of the most recent intra-session user activity, which can include recent changes in user intents or preferences.

When batch processing is used for feature generation, machine learning model output produced in the period between batch processes will not reflect the most recent user activity that has occurred since the last batch process was run. As a result, there is a significant risk that output produced by the recommendation system will not be responsive to the most recent user activity.

An input to a machine learning model can be referred to as a feature. Machine learning model features can include raw data items, such as the actual text input by a user into a search input box of a user interface or the actual text extracted from a digital content item, which may be referred to as raw features or low-level features. Features can, alternatively or in addition, include data items that are the result of one or more computations or transformations that have been performed on raw data items, and these features may be referred to as computed features, derived features, or high-level features. Computed features also can be derived from previously computed features rather than directly from raw features. Whether features are raw or computed, the recency of a feature can be referred to as its freshness.

Machine learning models that support recommendation systems based on user intent or preferences can consume, as model inputs, computed user activity features. An example of a computed user activity feature is an aggregation, such as a time-based aggregation. An example of a time-based aggregation is a count of the number of times a user viewed each page of the application during a particular time interval. Other examples of aggregations include sums, means, averages, probability distributions, histograms, average pooling computations, and sequential modeling. In other systems, these and other types of user activity features have been computed in batch processes or pre-computed offline and stored for later retrieval by machine learning models.

One reason for the need to use batch processing for machine learning model feature generation is that the feature generation processes often involve computing features that are a combination of real-time event data and traditionally batch-processed attribute data. However, it is a continuing technical challenge to reconcile real-time event processing and batch processing, especially with large data sets. Commentators familiar with the performance of Internet-based systems have acknowledged that it is “virtually impossible” to capture, query, and perform operations on real-time event data in combination with a batch processing system due to latency and throughput issues.

Additionally, due to the nature of a highly interactive online application system, any action that a user takes in the application system can reveal a change in the user's current intent and preferences. Thus, any user interface event potentially can trigger a request for machine learning model output that can be used by a recommender component of the application system to better personalize the user's in-application experience. When a high number of user interface events occur close together in time, continuously pre-computing features becomes impractical.

Experiments have shown that, with the use of other approaches that perform offline user activity feature generation, users have noticed that the system-provided recommendations have not been adjusted based on their most recent in-application activity. Thus, the reliance on batch processing for user activity feature generation can impact the recommendations provided by an application system in a way that is noticeable to the users.

For instance, offline activity data of infrequent users of an application system can be either too sparse or too far in the past to accurately reflect the users' current intent and preferences. The staleness of the users' offline activity data can result in poor personalization of recommendations for infrequent users of the application system. Also, offline activity data of frequent users of the application system might capture the users' longer-term intent and preferences (such as a general preference for content related to machine learning) but cannot capture the users' short-term intent and preferences (such as a specific preference for a currently trending topic such as a recent election or an upcoming sports championship), particularly where the users' intent and preferences can change from session to session or even within the same session.

Therefore, it has been and remains a continuing technical challenge to generate fresh computed user activity features for machine learning models that support recommendation systems based on user intent or user preferences.

Aspects of the present disclosure address the above technical challenges and/or other deficiencies of previously known activity feature generation approaches by computing activity features on-demand in response to a current user interface interaction, rather than periodically pre-computing the features or computing the features in batch processes. Embodiments enable user activity features to be computed in response to a feature request from a machine learning model and/or in response to a request for machine learning model output that has been made by a recommender system and/or in response to a current, online, user interface event.

On-demand activity feature computation is considered counterintuitive and non-scalable due to the large amount of activity data that needs to be processed in a short amount of time and, in a typical online application system, the high number of users (e.g., millions of users) simultaneously accessing the system.

To compute activity features on-demand, embodiments provide an activity feature generation system that leverages a real-time data store and a lightweight query computation framework that uses a minimal amount of memory to efficiently store and retrieve the most recent user event data related to a current user interface event of a particular user and related attribute data, and to compute user activity features on the most recent user event data fast.

In contrast to other approaches, in which batch jobs run feature computations for many users each having a large amount of user interface event data, the disclosed technologies use a per-user, per-user interface event approach that requires a much smaller amount of data to be processed and is much less likely to require a high degree of simultaneous data processing.

For instance, embodiments of the disclosed approaches do not compute user activity features until a user interface event triggers the need for the user activity features. Also, when the need for user activity features is triggered, embodiments of the disclosed approaches only compute user activity features for the particular user associated with the user interface event and only compute the particular types of features that are needed for the application system to respond to the particular user interface event that was triggered.

For example, if a user enters a search query, embodiments of the disclosed approaches will only compute those user activity features that are needed by the machine learning model that supports the search recommender that provides recommended search terms for the type of search query that has been entered (e.g., people search, job search, entity search). Also, embodiments of the disclosed approaches limit the size of the user interface event data set to user interface event data that pertains to the particular user that entered the search query. Additionally, as described in more detail below, embodiments of the disclosed approaches limit the amount of user interface event data used to compute the user activity features to only include event data that falls within a particular time window.

In an embodiment, historical user event data is stored in a scalable real-time database that is capable of serving many requests simultaneously (e.g., up to 6,000 queries per second) with low latency. Fine-granularity user interface events (e.g., “view,” “like,” etc.) are stored in the real-time database very quickly, e.g., within seconds after their occurrence. When a recommender system is invoked by a new or current, online, user interface event and the recommender system requests machine learning model output, the machine learning model receiving the request from the recommender system issues a feature request to the feature generation system. In response to the feature request from the machine learning model, the feature generation system queries the real-time database for the user's most recent events and performs a lookup of attribute information related to the user's most recent events retrieved from the real-time database. Examples of attribute data include categorical information such as standardized job titles, skills, or semantic embeddings.

The feature generation system uses the retrieved user event data and looked-up attribute data to compute the user activity features requested by the machine learning model. The feature generation system provides the computed user activity features to the machine learning model that issued the feature request. The fast computation of the user activity features enables the machine learning model to generate model output for the recommender system that requested the machine learning model output, and enables the recommender system to produce recommendations in response to the current, online user interface event, all within a time interval that meets the user's low latency expectations for the recommendations.

The ability to incorporate very recent user event data into the on-demand generation of user activity features improves the machine learning model output, which in turn increases the relevance of the recommendation system output in relation to current, online user activity.

User activity features computed by the activity generation system using the described approaches can better reflect a user's current intent and preferences based on the user's most recent interactions with the application system. At the same time, embodiments of the activity feature generation system architecture can produce the computed user activity features requested by a machine learning model within the performance and scalability constraints of an online system, in which users have come to expect a system response to inputs within a matter of milliseconds.

The fast computation of user activity features provided by the disclosed approaches makes the disclosed approaches suitable for situations in which very low latency is required. For example, embodiments of the disclosed approaches improve a user's feed while the user is scrolling the feed. Embodiments of the disclosed approaches generate user activity features based on the user's very recent scrolling actions and the content items associated with the user's scrolling activity. A feed recommender system can then use the computed user activity features to modify or rearrange the contents of the user's feed in real-time while the user continues scrolling.

The disclosed technologies are described with reference to an example use case of computing user activity features, on demand, for input to machine learning models that generate model output used by recommender systems to generate recommendations that are based on user intent and preferences.

Aspects of the disclosed technologies are not limited to user activity features or to user intent-oriented recommender systems but can be used to generate features for machine learning models on demand, more generally. For example, aspects of the disclosed technologies can be used to compute activity features based on many different types of time-based event data, such as sensor data and transaction data. An example of a computed activity feature in the context of sensor data could be a count of the number of geographic locations visited by a delivery driver within a specific time interval. An example of a computed activity feature in the context of transaction data could be a count of the number of ATM (automatic teller machine) withdrawals made within a particular time interval. The disclosed technologies can be used by many different types of network-based applications that include or are supported by machine learning models that use computed activity features as inputs.

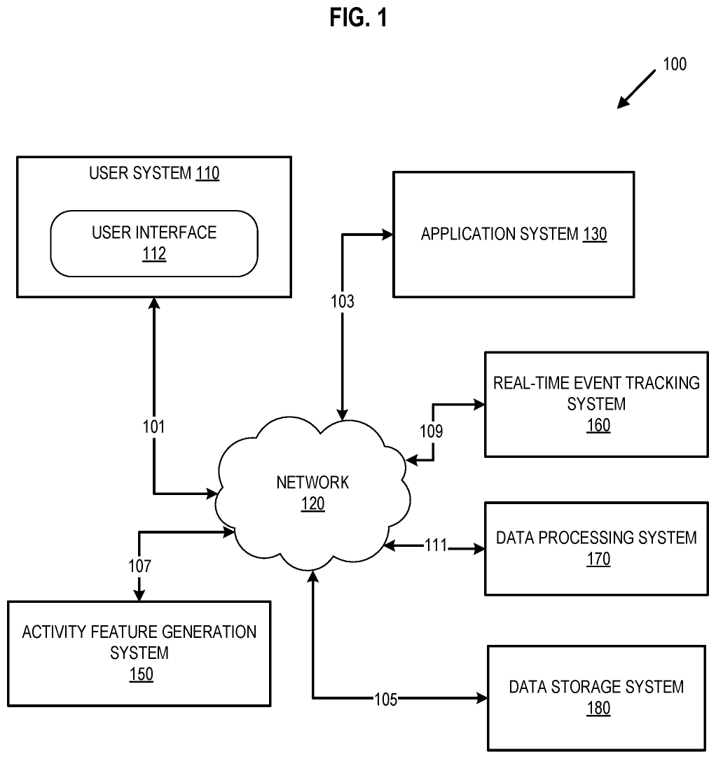

FIG. 1 illustrates an example computing system 100 that includes an activity feature generation system 150. In the embodiment of FIG. 1, computing system 100 includes a user system 110, a network 120, an application system 130, activity feature generation system 150, real-time event tracking system 160, data processing system 170, and data storage system 180.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 is or includes a front-end portion of application system 130, which may be implemented as a native application on a computing device or as a web application that launches in a web browser.

User interface 112 is any type of user interface as described above. User interface 112 can be manipulated by a user to input, upload, or share data, data records, and digital content items and/or to view or otherwise perceive data, data records, and digital content items distributed by application system 130. For example, user interface 112 can include a graphical user interface, haptic interface, and/or a conversational voice/speech interface that includes one or more mechanisms for viewing and manipulating digital content items.

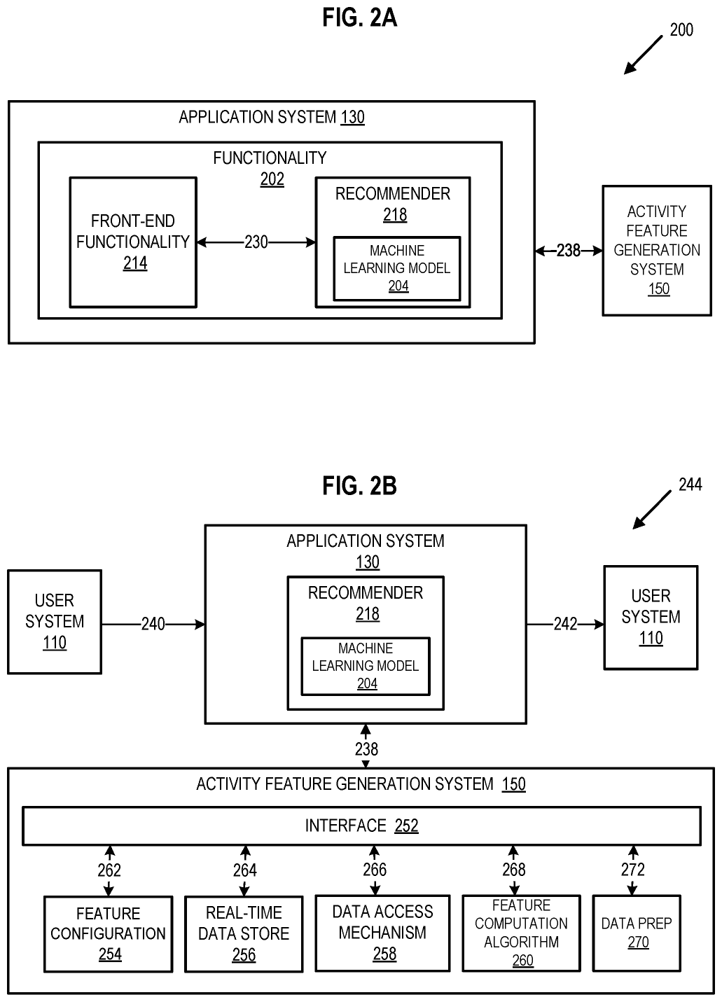

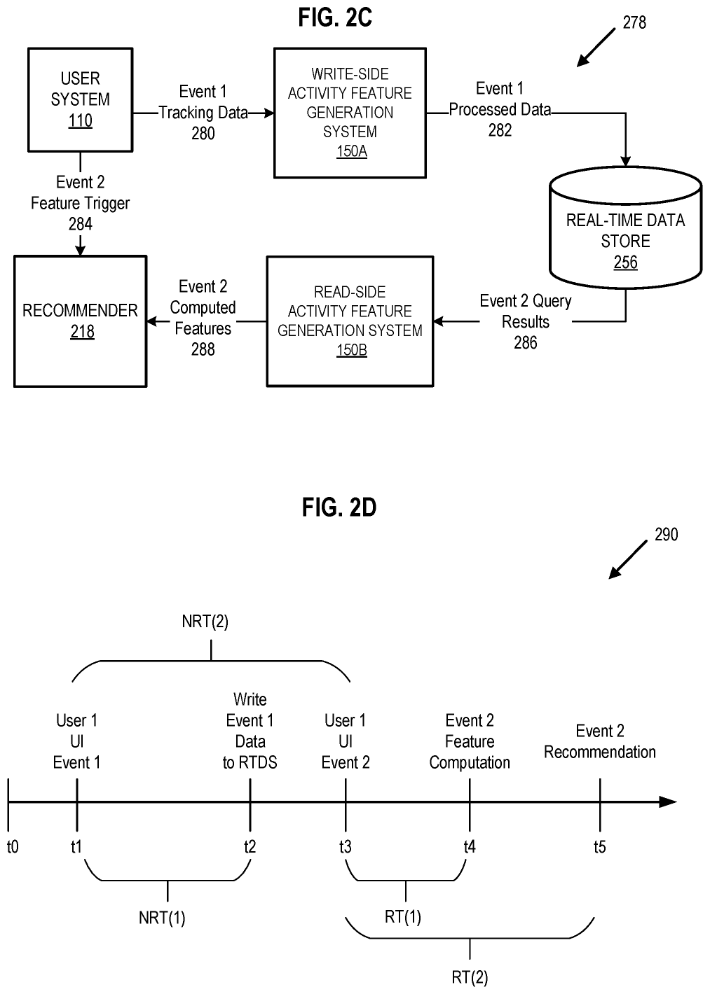

Application system 130 is any type of application software system that includes or utilizes functionality provided by activity feature generation system 150. Examples of application system 130 include but are not limited to connections network software, such as professional and/or general social media platforms, and systems that are or are not be based on connections network software, such as digital content distribution services, general-purpose search engines, job search software, recruiter search software, sales assistance software, advertising software, learning and education software, messaging software, e-commerce software, or any combination of any of the foregoing. An example embodiment of application system 130 is shown in FIG. 2A, described below.

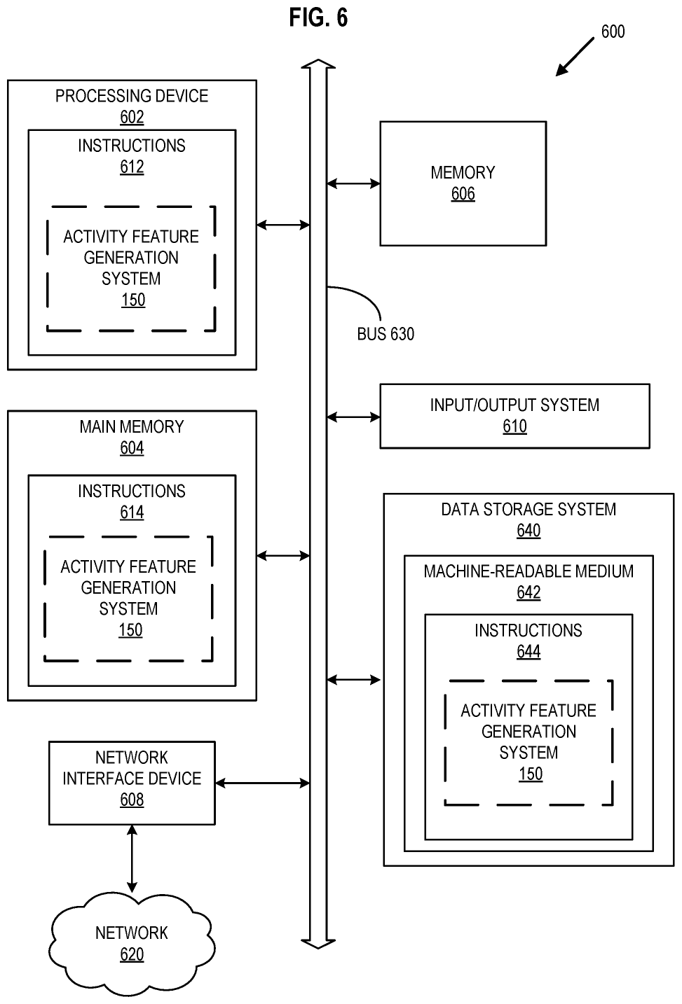

Activity feature generation system 150 is configured to generate, on demand, features used by machine learning models to produce model output. In some embodiments, application system 130 includes at least a portion of activity feature generation system 150. As shown in FIG. 6, embodiments of activity feature generation system 150 are implemented as instructions stored in a memory, and a processing device 602 is configured to execute the instructions stored in the memory to perform the operations described herein. Additional description of activity feature generation system 150 is provided below.

Real-time event tracking system 160 captures user interface events in real time and formulates them into a data stream that can be consumed by, for example, a stream processing system. For example, when a user of application system 130 clicks on a user interface control such as view, comment, share, like, or loads a web page, etc., real-time event tracking system 160 fires an event to capture the user's identifier, the event type, and the date/timestamp at which the user activity occurred. Real-time event tracking system 160 generates a data stream that includes one record of real-time event data for each user interface event that has occurred. Real-time event tracking system 160 is implemented using APACHE KAFKA in some embodiments.

“Time” as used in the context of terminology such as real-time, near real-time, and offline, can refer to the time delay introduced by the use of computer technology, e.g., by automated data processing and/or network transmission, where the time delay is the difference in time as measured by a system clock, between the occurrence of an online event and the use of data processed in response to the event, such as for display, feedback, and/or control purposes.

Data processing system 170 includes mechanisms for real-time data processing, near real-time processing, and batch processing, in some embodiments. Real-time data processing involves a continual input, such as a live feed, immediate, constant processing of the data stream, and steady output in response to the continual input. Real-time data processing involves low-latency messaging and event processing. An example of real-time data processing is data streaming, where the streaming data is not persisted for further analysis. In real-time data processing, the acceptable processing time is seconds, sub-seconds or less (e.g., milliseconds). An example of a tool that can be used for real-time data processing is APACHE SAMZA.

In contrast to real-time processing, near real-time data processing persists the incoming data and then processes the data. An example of a use of near real-time data processing is to combine data from multiple different data sources, for example to detect patterns or anomalies in the data. Examples of near real-time processing include processing sensor data, network monitoring, and online transaction processing. In near real-time data processing, the acceptable processing time is in the range of minutes or seconds. An example of a tool that can be used for near real-time, asynchronous data processing is APACHE SAMZA.

Offline or batch data processing is less time-sensitive than near real-time or real-time processing. In batch data processing, the acceptable processing time is in the range of days or hours. An example of a tool that can be used for batch data processing is APACHE HADOOP.

Data storage system 180 includes data stores and/or data services that store digital content items, data received, used, manipulated, and produced by application system 130, and data received, used, manipulated, and produced by activity feature generation system 150. Data storage system 180 can include multiple different types of data storage and/or a distributed data service. As used herein, data service may refer to a physical, geographic grouping of machines, a logical grouping of machines, or a single machine. For example, a data service may be a data center, a cluster, a group of clusters, or a machine.

Data stores of data storage system 180 can be configured to store data produced by real-time, near real-time (also referred to as nearline), and/or offline (e.g., batch) data processing. A data store configured for real-time data processing can be referred to as a real-time data store. A data store configured for near real-time data processing can be referred to as a near real-time data store or nearline data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 180 resides on at least one persistent and/or volatile storage device that can reside within the same local network as at least one other device of computing system 100 and/or in a network that is remote relative to at least one other device of computing system 100. Thus, although depicted as being included in computing system 100, portions of data storage system 180 can be part of computing system 100 or accessed by computing system 100 over a network, such as network 120.

Any of user system 110, application system 130, activity feature generation system 150, real-time event tracking system 160, data processing system 170, and/or data storage system 180 includes an interface embodied as computer programming code stored in computer memory that when executed causes a computing device to enable bidirectional communication with any other of user system 110, application system 130, activity feature generation system 150, real-time event tracking system 160, data processing system 170, and/or data storage system 180 using communicative coupling mechanisms 101, 103, 105, 107, 109, 111. Examples of communicative coupling mechanisms include network interfaces, inter-process communication (IPC) interfaces and application program interfaces (APIs).

In some embodiments, a client portion of application system 130 operates in user system 110, for example as a plugin or widget in a graphical user interface of a software application or as a web browser executing user interface 112. In an embodiment, a web browser transmits an HTTP request over a network (e.g., the Internet) in response to user input that is received through a user interface provided by the web application and displayed through the web browser. A server running application system 130 and/or a server portion of application system 130 receives the input, performs at least one operation using the input, and returns output using an HTTP response that the web browser receives and processes.

Other technologies that can be used to effectuate communications of data and instructions between any of user system 110, application system 130, activity feature generation system 150, real-time event tracking system 160, data processing system 170, and/or data storage system 180 include application programming interfaces (APIs) such as REST (representational state transfer) APIs and SOAP (simple object access protocol), scripting languages such as JavaScript, markup languages such as XML (extensible markup language) and JSON (JavaScript object notation), and AJAX (asynchronous JavaScript and XML).

Each of user system 110, application system 130, activity feature generation system 150, real-time event tracking system 160, data processing system 170, and/or data storage system 180 is implemented using at least one computing device that is communicatively coupled to electronic communications network 120 using communicative coupling mechanisms 101, 103, 105, 107, 109, 111. Any of user system 110, application system 130, activity feature generation system 150, real-time event tracking system 160, data processing system 170, and/or data storage system 180 are bidirectionally communicatively coupled by network 120. User system 110 as well as one or more different user systems (not shown) are bidirectionally communicatively coupled to application system 130 while application system 130 is accessed by a user of user system 110.

A typical user of user system 110 is an administrator or an end user of application system 130 and/or activity feature generation system 150. An administrator or an end user can be a human person or a computer program designed to simulate human use of application system 130, such as a bot. User system 110 is configured to communicate bidirectionally with any of user system 110, application system 130, activity feature generation system 150, real-time event tracking system 160, data processing system 170, and/or data storage system 180 over network 120 using communicative coupling mechanism 101. User system 110 has at least one address that identifies user system 110 to network 120 and/or application system 130; for example, an IP (internet protocol) address, a device identifier, a MAC (media access control) address, a session identifier, a user account identifier, or any combination of any of the foregoing.

The features and functionality of user system 110, application system 130, activity feature generation system 150, real-time event tracking system 160, data processing system 170, and/or data storage system 180 are implemented using computer software, hardware, or software and hardware, and can include combinations of automated functionality, data structures, and digital data, which are represented schematically in the figures. User system 110, application system 130, activity feature generation system 150, real-time event tracking system 160, data processing system 170, and/or data storage system 180 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

Network 120 is implemented on any medium or mechanism that provides for the exchange of data, signals, and/or instructions between the various components of computing system 100. For example, data and instructions can be represented as signals, where a signal includes a series of bits, and a bit value corresponds to a designated level of electrical charge that can traverse network 120 and be received and processed by devices on network 120. Examples of network 120 include, without limitation, a Local Area Network (LAN), a Wide Area Network (WAN), an Ethernet network, the Internet, at least one terrestrial, satellite or wireless link, or a combination of any number of different networks and/or communication links.

FIG. 2A is an example of an application system in communication with an activity feature generation system in accordance with some embodiments of the present disclosure. In FIG. 2A, application system 130 includes functionality 202, recommender 218, and machine learning model 204.

Application system 130 includes many more components than are shown in FIG. 2A, such as databases and network services, but those details are omitted from FIG. 2A for ease of discussion. For example, in some embodiments, application system 130 includes entity data, activity data, content item data, and a social graph. Entity data, activity data, content item data, and social graph are included in an embodiment in which application system 130 is a social network application. Other embodiments of application system do not include one or more of entity data, activity data, content item data, and social graph. Application system 130 is in bidirectional digital communication with activity feature generation system 150 via communicative coupling 238.

Functionality 202 includes front-end functionality 214 and recommender 218. Front-end functionality 214 enables data manipulations and communications between users of application system 130, represented as entities in application system 130, and application system 130. An entity in application system 130 is a logical construct that is linked with an address of a physical user system 110. A user system 110 can be associated with more than one entity in application system 130. For example, a physical user system 110 can be associated with multiple different logical account identifiers, and a logical account identifier in application system 130 can be associated with multiple different physical user systems 110 (e.g., a smartphone, a smartwatch, and a laptop). Examples of entity types include users, companies, organizations, jobs, and content items. Data manipulations and communications performed by a user system 110 in application system 130 can be described with reference to an entity associated with the user system 110.

Front-end functionality 214 includes functionality that is exposed to users of application system 130 through a user interface. Front-end functionality 214 includes, for example, user interface features and functions that enable users to scroll a feed of digital content items, enter and execute search queries, follow other entities, view, like, create, upload, share, forward, reply to, and save data, data records, and digital content items, including system-generated recommendations, in application system 130, to view, like, add, edit, and delete comments and replies to comments on digital content items, and to view, send and receive messages with other users of application system 130. Embodiments of front-end functionality 214 also include user interface features and functions that enable users to view, like, share, and otherwise manipulate data, data records, and digital content items presented in a search result, a feed, a recommendation, a notification, or a message generated by application system 130.

In application system 130, front-end functionality 214 and recommender 218 are enabled by Internet communications technologies. For example, front-end functionality 214 that enables viewing of a digital content item in application system 130 includes the sending and receiving of network messages between the user system viewing the digital content item and application system 130. Front-end functionality 214 that enables searching for, viewing and manipulation of data, a data record, or a digital content item in application system 130 includes the sending and receiving of network messages between the user system viewing and/or manipulating the data, data record, or digital content item and application system 130. In some contexts, network messages are referred to as requests. Also, front-end functionality 214 and recommender 218 can be asynchronous.

Recommender 218 is a portion of back-end functionality of application system 130. Back-end functionality includes computer operations, such as data manipulations and communications, that support the front-end functionality 214. For example, embodiments of back-end functionality include computer execution of machine learning algorithms that provide output that can be used by front-end functionality 214 to configure user interface output. Embodiments of back-end functionality include execution of queries against one or more data stores. Back-end functionality includes execution of machine learning algorithms that provide output that can be used by front-end functionality 214 to configure and populate a search result, a feed, a notification, a message, a push notification, or a recommendation, in some embodiments. Algorithms executed as part of back-end functionality 216 include, e.g., rules engines, heuristics, and/or machine learning algorithms that have been trained using one or more data sets of training data.

An example of a recommender 218 is a job recommender system that generates job recommendations. Another example of a recommender 218 is a feed ranking system that ranks, orders, or groups digital content items for inclusion in a user's feed. Another example of a recommender 218 is a smart search suggestion system that generates search term suggestions for a user's search. Another example of a recommender 218 is a profile recommender system that generates entity profile recommendations for viewing or connection requests. Another example of a recommender 218 is a digital content item recommender system that generates recommendations for digital content items to display on a portion of the user interface.

Recommender 218 is in bidirectional digital communication with front-end functionality 214 via communicative coupling 230. More specifically, portions of front-end functionality 214 are in bidirectional digital communication with one or more recommenders 218. In an embodiment, a search interface portion of front-end functionality 214 issues a call to a search recommender 218 for the search recommender 218 to group, sort, filter, or rank a set of search results, and search recommender 218 returns a grouped, sorted, filtered, or ranked set of search results to the search interface portion of front-end functionality 214.

As another example, a feed interface portion of front-end functionality issues a call to a feed recommender 218 for the feed recommender 218 to group, sort, filter, or rank a set of digital content items to populate a user's feed, and feed recommender 218 returns a grouped, sorted, filtered, or ranked set of digital content items to the feed interface portion of front-end functionality 214, in some embodiments. Similar interactions between other portions of front-end functionality 214, such as connection recommendation and job recommendation portions of front-end functionality 214, and corresponding recommenders 218, also occur, in some embodiments. Thus, while only a single recommender 218 is shown, functionality 202 can include multiple different recommenders 218 that each serve a different portion of front-end functionality 214.

Recommender 218 includes a machine learning model 204 or, in other embodiments, is in bidirectional digital communication with a machine learning model, for example via an interface. For example, a recommender 218 issues a call or query containing a request for model output to a machine learning model 204, and machine learning model 204 returns the requested model output to the recommender 218 that issued the call or query, in some embodiments.

Recommender 218 and other back-end functionality of application system 130 are executed by a server computer or network of servers, in some embodiments. Portions of back-end functionality, including portions of recommender 218, are implemented on a client device, e.g., a user system 110, in some embodiments. Front-end functionality 214 is executed by a client device, e.g., a user system 110, in some embodiments. Portions of front-end functionality 214 are implemented on a server computer or network of servers, in some embodiments.

Machine learning model 204 is, in some embodiments, a combination of data and computer code that reflects relationships between sets of inputs and the outputs produced by the application of a machine learning algorithm to those sets of inputs. After a machine learning model has been trained, these relationships between inputs and outputs are reflected in the values of the machine learning algorithm parameters and/or coefficients. For example, application of a machine learning algorithm to training data adjusts the values of machine learning model parameters and/or coefficients iteratively until parameter and/or coefficient values are found that produce statistically reliable output, e.g., predictions, classifications, inferences, or scores. A loss function is used to compute model error (e.g., a comparison of model-generated values to validated or ground-truth values) at an iteration, in order to determine whether the model is producing reliable output or whether to adjust parameter and/or coefficient values.

Machine learning algorithm can refer to a single algorithm applied to a single set of inputs, multiple iterations of the same algorithm on different inputs, or a combination of different algorithms applied to different inputs. For example, in a neural network, a node corresponds to an algorithm that is executed on one or more inputs to the node to produce one or more outputs. A group of nodes each executing the same algorithm on a different input of the same set of inputs can be referred to as a layer of a neural network. The outputs of a neural network layer can constitute the inputs to another layer of the neural network. A neural network can include an input layer that receives and operates on one or more raw inputs and passes output to one or more hidden layers, and an output layer that receives and operates on outputs produced by the one or more hidden layers to produce a final output.

The selection of machine learning algorithm, loss function, and associated parameter and/or coefficient values can be dependent on the requirements of the particular application system; e.g., the type of output desired to be produced and the nature of the inputs. For purposes of this disclosure, activity feature generation system 150 is agnostic as to the type and configuration of any particular machine learning model 204 from which it receives a feature request. Machine learning model 204 is hosted by a server computer or network of servers, in some embodiments. Portions of machine learning model 204 are implemented on a client device, e.g., a user system 110, in some embodiments.

Machine learning model 204 is in bidirectional digital communication with activity feature generation system 150 via communicative coupling 238. Recommender 218, and more particularly, machine learning model 204, issues calls or queries, or sends data and/or instructions to activity feature generation system 150 over communicative coupling 238, in some embodiments. Activity feature generation system 150 issues calls or queries, or sends data and/or instructions to recommender 218 or more specifically machine learning model 204 over communicative coupling 238, in some embodiments.

For example, to respond to a call or trigger from a recommender 218, machine learning model 204 issues a call or query containing a feature request and associated parameter values or arguments to activity feature generation system 150 over communicative coupling 238, in some embodiments. In response to a call or query from machine learning model 204, activity feature generation system 150 generates the activity features requested by machine learning model 204 in accordance with the parameter values or arguments specified in the call, and returns to machine learning model 204 the computed activity features corresponding to the parameter values or arguments contained in the call, in some embodiments. Examples of parameter values or arguments that can be contained in a feature request issued by a machine learning model 204 to activity feature generation system 150 include a user identifier, an entity identifier, an event identifier, a request timestamp, or any combination of the foregoing.

FIG. 2B illustrates an example of flow 244 of an application system including a machine learning model 204, a recommender 218, and activity feature generation system 150 in accordance with some embodiments of the present disclosure. As described in more detail below with reference to FIG. 2C and FIG. 2D, portions of flow 244 are implemented as online, nearline, or real-time operations, in some embodiments.

In the example of FIG. 2B, application system 130, including recommender 218 and machine learning model 204, is an online system. Activity feature generation system 150 contains an interface 252 that is responsive to calls from machine learning model 204 while machine learning model 204 and recommender 218 are online. Application system 130 receives incoming digital communications from a client device of user system 110 via a communicative coupling 240. For example, user system 110 can log in to application system 130, load a page of application system 130, input a search query, click in a search input box, or tap a user interface control at user interface 112. User system 110 communicates these and/or other user interface events to application system 130 over communicative coupling 230 via network messages.

In response to an incoming digital communication from a user system 110, application system 130 determines to invoke a recommender 218. For example, if user system 110 has loaded a web page that contains a recommendation module, application system 130 invokes recommender 218.

To provide recommendations for the recommendation module, recommender 218 invokes machine learning model 204. In some embodiments, recommender 218 sends a request for model output to machine learning model 204 over communicative coupling 238. In response to the request for model output issued by recommender 218, machine learning model 204 sends a feature request to activity feature generation system 150 over communicative coupling 238. Activity feature generation system 150 generates activity features in accordance with the feature request received from machine learning model 204, and returns the requested activity features to machine learning model 204 via communicative coupling 238.

In response to receiving the requested activity features from activity feature generation system 150, machine learning model 204 applies a machine learning algorithm to a set of model inputs that includes the requested activity features to produce machine learning model output. Recommender 218 uses the machine learning model output received from machine learning model 204 to formulate a recommendation for configuring user interface 112 at the client device.

Application system 130 sends the recommendation generated by recommender 218 to the client device of user system 110 from which the digital communication was received. In this way, application system 130 uses activity features generated on demand by activity feature generation system 150 in response to a feature request from machine learning model 204 to formulate a recommendation, configure a user interface of user system 110, or otherwise respond to the digital communication received from user system 110, all during the same session in which user system 110 is connected to application system 130 online.

In the example of FIG. 2B, activity feature generation system 150 is a software application hosted on a computing device that facilitates online feature access by machine learning models. In some embodiments, portions of activity feature generation system 150 are implemented as an online feature generation service or “virtual feature store.” Activity feature generation system 150 includes an interface 252, a feature configuration 254, a real-time data store 256, a data access mechanism 258, a feature computation algorithm 260, and data preparation 270. Feature configuration 254, real-time data store 256, data access mechanism 258, feature computation algorithm 260, and data preparation 270 are communicatively coupled to interface 252 by bidirectional communicative couplings 262, 264, 266, 268, 272, respectively.

Interface 252 is an application program interface (API), hosted on the computing device, that includes an online feature access layer, in some embodiments. The online feature access layer is invoked by machine learning model 204 to send feature requests to activity feature generation system 150 and to receive computed user activity features from activity feature generation system 150. Application system 130, or more particularly, recommender 218 or machine learning model 204, accesses activity features computed by activity feature generation system 150 through interface 252 or more particularly through feature configurations 254. Interface 252 communicates bidirectionally with machine learning model 204 via communicative coupling 228.

A feature request received from a machine learning model 204 includes a user identifier, e.g., the user identifier associated with a current user interface activity at user system 110, in some embodiments. The feature request also contains a feature identifier, such as a feature name or a unique numerical identifier, of the requested feature. The feature request contains a request timestamp that corresponds to either the timestamp of the current user interface activity that triggered the feature request or the timestamp of the feature request itself, in some embodiments. The feature request contains a requested time window over which the activity features are to be generated for a particular machine learning model 204, in some embodiments. Alternatively, a time window is specified in a feature configuration 254 for a particular type of feature.

When interface 252 receives a feature request from machine learning model 204, interface 252 obtains inputs needed by feature computation algorithm 260 to produce the requested features in accordance with arguments or parameters supplied in the feature request. Interface 252 provides the features generated by feature computation algorithm 260 to machine learning model 204 in response to the received feature request.

To determine the particular feature computation algorithm 260 to be executed to generate the features requested by machine learning model 204 and the set of inputs needed by the feature computation algorithm 260 to generate those features, interface 252 reads a feature configuration 254. In some embodiments, at least interface 252 is part of application system 130 and feature configuration 254 is implemented as a resource that is incorporated into application system 130 at runtime. Thus, in some embodiments, reading a feature configuration 254 includes reading the feature configuration portions of the application system code into memory for execution by a processor.

Also, while illustrated as separate elements in FIG. 2B, in some embodiments, data access mechanism 258 and feature computation algorithm 260 are contained in feature configuration 254. Thus, in embodiments in which feature configuration 254 is implemented as a resource, feature configuration 254, including data access mechanism 258 and feature computation algorithm 260, are incorporated into application system 130, at least at runtime.

Feature configuration 254 is one feature configuration of a library of feature configurations that are stored and maintained by activity feature generation system 150. Each feature configuration 254 in the library is pre-defined for a particular feature. For example, a feature configuration 254 can be hand-crafted by a user such as a feature engineer. Once created, a feature configuration 254 is added to the library of feature configurations in activity feature generation system 150 and is accessible through interface 252. Each feature configuration 254 is identified by a different feature configuration identifier.

An example of a feature configuration is computer code that, when executed by a processor, obtains a list of events or entities with which a user associated with a particular user ID has interacted within application system 130 (for example, a list of job IDs of all jobs the user has applied to through application system 130).

Another example of a feature configuration is computer code that, when executed by a processor, stores and retrieves attribute information about a user's events, e.g., entities with which the user interacts within application system 130. For example, for a job ID, the feature configuration can store or retrieve job title and company name associated with that job ID.

The feature computation algorithm 260 contains the specifications for how to obtain the raw entity data and attribute data needed to generate the activity features, e.g., how to obtain the list of job IDs applied to by the user ID, and how to sequentially lookup the job title/company name associated with each job ID. Feature computation algorithm 260 also applies the aggregation operation specified by the feature configuration to the raw entity/attribute data to create the activity features.

To determine the particular feature configuration 254 to read in response to the feature request from machine learning model 204, interface 252 maps the feature request received from machine learning model 204 to the feature configuration identifier. For example, interface 252 matches a feature name contained in the feature request to a feature configuration identifier or a feature name associated with the feature configuration identifier in the library of feature configurations.

A feature configuration 254 contains the specifications for computing an activity feature. These specifications are expressed in a computer-interpretable language such as MVEL (MVFLEX expression language). Feature configuration 254 identifies the data sources that store the raw data to be used to compute the activity feature, including, for user interface event data, real-time data store 256. An example of a type of data store that can be used to implement real-time data store 256 is a real-time distributed OLAP (online application processing) datastore, such as APACHE PINOT.

Feature configuration 254 also specifies one or more data access mechanisms 258 that interface 252 uses to obtain the raw data needed to compute the activity feature from the identified data sources, in some embodiments. Examples of data access mechanisms 258 include executable queries, including queries that are in a format that can be executed against real-time data store 256 and/or other types of data stores. For instance, data access mechanisms 258 includes PINOT queries and sequential lookups that are used to obtain data from, e.g., key-value stores, in some embodiments.

Feature configuration 254 indicates a time window for obtaining the raw data needed to compute the activity feature. Alternatively, the time window is specified in the feature request from machine learning model 204. The time window specifies the interval of time counting backward from the request timestamp over which to obtain the raw data used to compute the activity features. An example of a time window is “the last N days,” where N is a positive integer. In some embodiments, N=5. Thus, the time window determines the amount of historical user event data to include in the activity feature generation, potentially up to and including the moment of the request timestamp. Keying the time window off of the request timestamp allows activity feature generation system 150 to obtain the most recent event data stored in real-time data store 256.

Feature configuration 254 also contains feature computation algorithm 260 or a pointer to the location of feature computation algorithm 260. Feature computation algorithm 260 contains the algorithmic step or steps that need to be executed in order to compute the requested activity features. For example, a feature computation algorithm 260 could include instructions such as get event data that matches a user identifier and falls within a specified time window from the real-time data store, look up attribute data that maps to the retrieved event data, and perform an aggregation on the attribute data mapped to the retrieved event data. Feature computation algorithm 260 is expressed in a computer-interpretable language, for example, MVEL.

After reading the feature configuration 254 that corresponds to the feature request from machine learning model 204, interface 252 executes the feature computation algorithm 260. For example, interface 252 obtains the raw event data from real-time data store 256 that matches the specified user identifier and time window, and obtains the corresponding attribute data, using the data access mechanisms specified in feature configuration 254.

Interface 252 applies the data transformation steps specified in feature computation algorithm 260 to the retrieved event data and associated attribute data to compute the requested features. For example, interface 252 executes a query against real-time data store 256 to get the most recent N days of a particular event type associated with the user identifier (e.g., the last 4 days of job application submission events associated with the user identifier), look up the corresponding attribute data from a key-value store (e.g., job titles associated with the retrieved job application submission events), and execute the data transformation(s) specified by the feature computation algorithm 260 using the retrieved event data and looked-up attribute data as inputs to produce the activity features requested by machine learning model 204.

A time-based aggregation is one example of a data transformation that is specified by a feature computation algorithm, in some embodiments. Alternatively or in addition, other types of computations, such as data cleaning or feature imputation, are specified by the feature computation algorithm 260. Interface 252 returns the computed activity features to machine learning model 204 via communicative coupling 228.

The availability of activity data in real-time by way of real-time data store 256 can significantly improve the quality of recommendations served by recommender systems such as recommender 218. For example, recent user interface events of a user can reveal the short-term intent and preferences of that user. Incorporating recent user interface events into activity feature generation can enable recommender 218 to adapt recommendations for the user in real-time to better serve the current intent and preferences of the user.

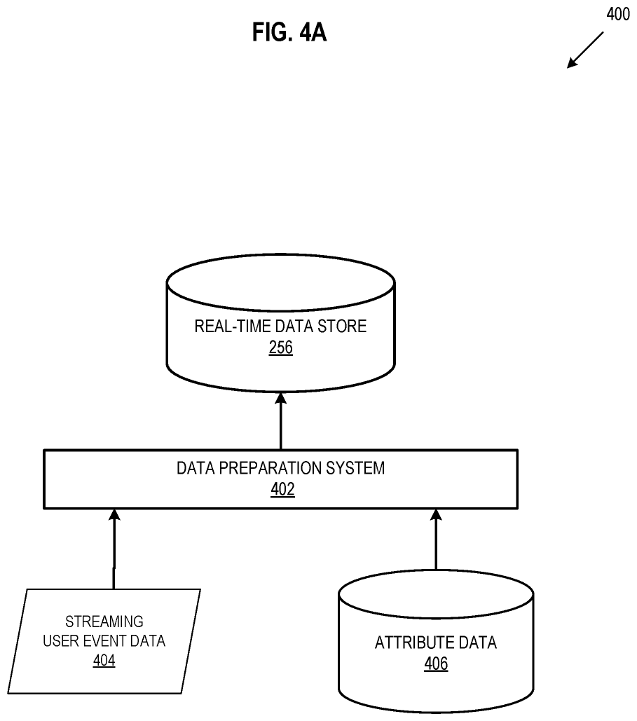

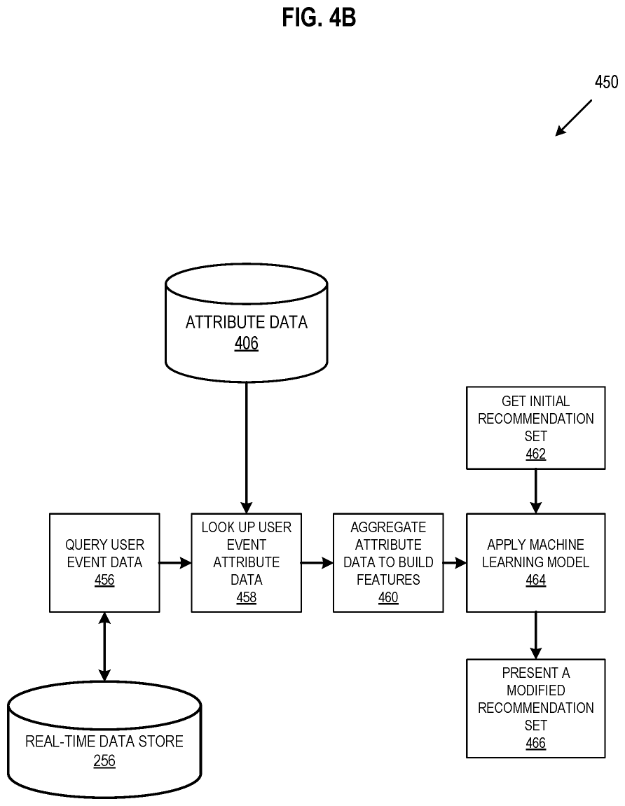

Data preparation 270 collects streaming user event tracking data from data streams generated by real-time event tracking system 160, formats the collected data for storage in real-time data store 256, and stores the formatted data in real-time data store 256. Data stored in real-time data store 256 by data preparation 270 is available for activity feature generation according to feature configuration 254. An example of data preparation 270 is shown in more detail in FIG. 4A, described below.

FIG. 2C is a flow diagram showing a method 278 for activity feature generation in accordance with some embodiments of the present disclosure. As shown in FIG. 2C, activity feature generation system 150 includes a write-side portion 150A and a read-side portion 150B. While a user is interacting with application system 130 through user system 110, write-side portion 150A listens to and processes user interface events of interest from the real-time event stream produced by real-time event tracking system 160 during the user's online session. An example of an instance of a user interface event of interest is event 1 tracking data 280. Event 1 tracking data 280 includes, for example, event-specific values for user ID, event ID, and date/timestamp.

Write-side portion 150A is a stream processor that executes lightweight processing logic on the data stream, such as filtering out events that are not of interest for creating user activity features and stream-table joins. For example, write-side portion 150A filters out events in which the value in the user ID field is null because a null user ID signifies that the event was an action taken by a bot and not by a human user of application system 130, in some embodiments.

Write-side portion 150A performs stream-table joins to join attributes of entities identified in particular events of the real-time tracking data to produce processed event data. An example of processed event data is event 1 processed data 282. An example of an instance of event 1 processed data 282 is user ID, event ID, date/timestamp, attribute1, attribute2.

An example of an event is a job search, and an attribute of a job is job title. In this example, when a job search event is extracted from the real-time data stream, write-side portion 150A joins the job title attribute with the job search event. Attribute data is stored in one or more data stores of data storage system 180. In some embodiments, attribute data is obtained by write-side portion 150A from one or more distributed storage systems such as VENICE. In some embodiments, a VENICE store contains attributes for each job ID, such as its embedding and/or the geographic location of the job.

After joining the attributes to the event data, write-side portion 150A creates and emits a new streaming event that contains the event data and the joined attribute data. Write-side portion 150A formats the new event using a schema that matches the schema of real-time data store 256. The new event is added to the event stream generated by real-time event tracking system 160. Real-time data store 256 ingests the new event as a new row in real-time data store 256. Thus, each row of real-time data store 256 corresponds to a different user interface event and potentially can be used to generate user activity features.

Once real-time data store 256 is populated with event data for user interface events of interest, real-time data store 256 can be queried by read-side portion 150B of activity feature generation system 150 to obtain event data, which read-side portion 150B uses to compute activity features. For example, a second user interface event by the same user in the same session can trigger the need for read-side portion 150B to compute activity features for recommender 218. This is illustrated by event 2 feature trigger 284. In response to event 2 feature trigger 284, recommender 218 causes real-time data store 256 to be queried by read-side portion 150B. In response to the query, read-side portion computes event 2 computed features 288 using event 2 query results 286. Recommender 218 applies machine learning model 204 to event 2 computed features 288. Recommender 218 uses the output of machine learning model 204 to create a recommendation, which is provided to user system 110 in response to event 2 feature trigger 284.

FIG. 2D is an example of a timeline 290 for activity feature generation in accordance with some embodiments of the present disclosure. Timeline 290 illustrates a temporal sequence of activities that can occur using method 278 of FIG. 2C. In timeline 290, elements tn, where n is a positive number, are timestamps but the distance between the timestamps is not necessarily to scale. For example, the time interval between t1 and t2 could be measured in seconds while the time interval between t3 and t3 is measured in milliseconds. At time t0, application system 130 is launched on a device used by a user 1.

At time t1, a user 1 user interface (UI) event 1 occurs. User 1 event 1 is a user interface event of interest, such as a job view, a people search, or a loading of a web page, by user 1 during the session started at t0. User 1 UI event 1 triggers a write event to a real-time data stream. Continuing in the same user 1 session, write-side portion 150A of activity feature generation system 150 writes event 1 and any joined attribute data to real-time data store 256. Using the write-side data preparation technologies described herein, the time interval between t1 and t2 is expected to be a near real-time time interval NRT(1), which can be in the range of about, e.g., ten seconds or less.

At time t3, a second user interface event occurs in the same user session. In a typical pattern of user interactions with application system 130, the time interval between t1 and t3 is expected to be a near real-time time interval NRT(2), which can be in the range of about, e.g., a few seconds or less. User 1 UI event 2 triggers recommender 218, which triggers the need for activity feature computations. At event 2 feature computation time t4, read-side portion 150B of activity feature generation system 150 runs the process of querying real-time data store 256 and generating computed features using the query results. In contrast to other approaches in which features are pre-computed offline for all users and all event types, the computed features generated at t4 are specific to the particular user ID and the particular event trigger that occurred at t3. This on-demand feature computation is user-specific and event-specific.

Using the read-side on-demand feature generation technologies described herein, the time interval between t3 and t4 is expected to be a real-time time interval RT(1), which can be in the range of about, e.g., one hundred milliseconds to five hundred milliseconds or less. At time t5, recommender 218 generates a recommendation responsive to user 1 UI event 2, using the activity features computed at t4. Using the disclosed approaches, the time interval between t3 and t5 is expected to be a real-time time interval RT(2) as a result of the RT(1) time interval between t3 and t4.

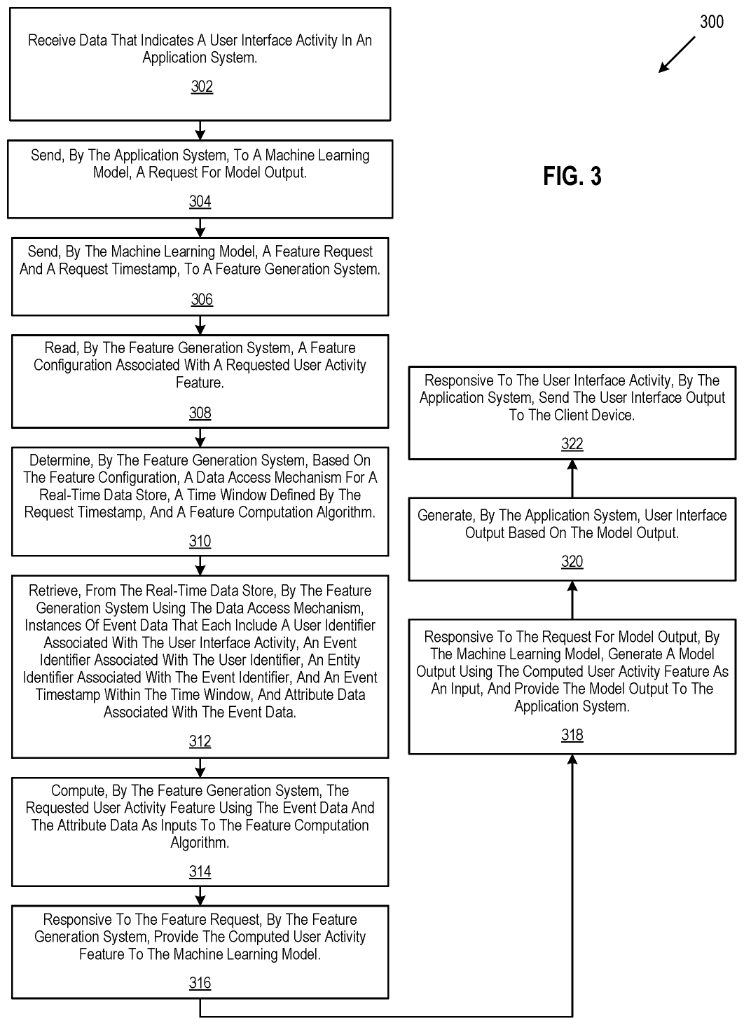

FIG. 3 is a flow diagram of an example method to compute an activity feature for a machine learning model in accordance with some embodiments of the present disclosure.

The method 300 is performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the activity feature generation system 150 of FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the processing device receives, at an application system that uses output of a machine learning model to configure a user interface in response to user activity, from a client device, data that indicates a user interface activity in the application system. An example of data that indicates a user interface activity in the application system is a user interface event in a stream of real-time event data. Examples of user interface events include view, share, comment, like, follow, search, connect, etc.

At operation 304, the processing device sends, by the application system, to the machine learning model of operation 302, a request for model output. The request for model output is generated and/or sent by, for example, a recommender component of the application system that uses machine learning model output to generate recommendations for configuring a portion of a user interface of the application system, in some embodiments.

At operation 306, the processing device sends, by the machine learning model, a feature request and a request timestamp to a feature generation system. An example of a feature request is a query or an API call to activity feature generation system 150. The machine learning model of operation 302 generates a feature request in response to receipt, by the machine learning model, of the request for model output of operation 304, in some embodiments. The machine learning model sends the feature request through an interface, e.g., an application programming interface (API), of the feature generation system, in some embodiments. The request timestamp is determined, for example, based on the data that indicates the user activity in the application system at operation 302.

At operation 308, the processing device reads, by the feature generation system, a feature configuration associated with the feature request. In some embodiments, the feature configuration is a pre-created specification for generating activity features, which is maintained in a library of the feature generation system. The feature configuration used by the processing device in method 300 identifies a real-time data store as a data source for computing the features and includes an online data access mechanism for querying the real-time data store while application system 130 is online. Also, in contrast to feature configurations for offline feature generation, the feature configurations for the real-time generated features described herein also include feature computation logic. Offline approaches do not typically include feature computation logic because the features are pre-computed. Operation 308 determines which feature configuration of the library to read by, for example, matching a feature name specified in the feature request with a feature name associated with the feature configuration.

At operation 310, the processing device determines, by the feature generation system, based on the feature configuration, a data access mechanism for a real-time data store, a time window defined by the request timestamp, and a feature computation algorithm. In some embodiments, the data access mechanism, time window, and feature computation algorithm are determined by reading the feature configuration identified as corresponding to the feature request in operation 308.

An example of a data access mechanism is a portion of the feature configuration that identifies a real-time data source and a location of the data source, e.g., a path or URL that can be traversed by the feature generation system to retrieve data from the data source. The data access mechanism also includes a data access query in a format that can be executed on the real-time data source to retrieve data from the real-time data source. The time window is specified as a function of the request timestamp; e.g., a number x of time increments (e.g., seconds, minutes, hours, days) prior to the request timestamp, in some embodiments. For example, the time window can be specified as the previous x days, counting backwards from the day of the request timestamp, such that the data used to generate the computed features includes only event data having an event timestamp within x days prior to, up to and including the day of the request timestamp. In other words, the time window determines the recency of data used to generate the computed features. The feature computation algorithm specifies one or more data transformations, such as aggregations, to be performed on data retrieved from the real-time data source.

At operation 312, the processing device retrieves, from the real-time data store, by the feature generation system using the data access mechanism, instances of event data that each comprise a user identifier associated with the user interface activity of operation 302, an event identifier associated with the user identifier, an entity identifier associated with the event identifier, and an event timestamp within the time window, and attribute data associated with the event data.

For example, an instance of real-time user interface event data that can be retrieved from the real-time data store can include a user identifier=user1; event identifier=view; entity identifier=job; event timestamp=t1[a timestamp value within (request timestamp−time window)]. Another instance of real-time user interface event data can include, for the same user identifier, a different event identifier and a different timestamp; e.g., user1, search, t2. As another example, an instance of the event data can include a job search, a job view, a job application, or a job dismiss.

An example of attribute data associated with the event data is, for a view job event, the job title of the viewed job. Another example of attribute data is, for a search event, a search term entered by the user in the search interface.

At operation 314, the processing device computes, by the feature generation system, a user activity feature using the instances of event data retrieved in operation 312 and the attribute data obtained in operation 312 as inputs to the feature computation algorithm. For example, the feature generation computes an aggregation of event attribute data, such as count of the number of times the user viewed a job within the time window. Other examples of aggregations that can be used to compute user activity features are mentioned in other parts of this disclosure.

At operation 316, the processing device provides, responsive to the feature request of operation 306, by the feature generation system, the user activity feature computed in operation 314 to the machine learning model. The computed user activity feature is provided to the machine learning model through the interface, e.g., API, of operation 306.

At operation 318, the processing device generates, responsive to the request for model output, by the machine learning model, a model output using the computed user activity feature as an input, and provides the model output to the application system. For example, machine learning model output is provided to a recommendation component of the application system.

At operation 320, the processing device generates, by the application system, user interface output based on the model output provided to the application system in operation 318. For example, a recommendation component of the application system ranks, groups, sorts, or filters a set of recommendations, such as recommended content items, based on the machine learning model output. For instance, where the activity feature indicates a high number of view job events within the time window, the application system uses the machine learning model output to configure a recommendation portion of the user interface to include a recommendation to submit a job application for a particular job.

As another example, where the activity feature indicates recent views of feed items of a particular topic by the user and/or the user's first-degree connections, the application system uses the machine learning model output to configure a recommendation portion of the user interface to rank content items that belong to that topic higher in the user's feed. In yet another example, where the activity feature indicates that recent activities of a user (connect, follow, profile view, interaction with feed updates, etc.) relate to certain topics, the application system uses the machine learning output to formulate search suggestions based on the user's recent activities with respect to those topics when the user enters a search query.

The application system generates the user interface output based on the ranked, grouped, sorted, or filtered set of recommendations provided by the recommendation component. At operation 322, responsive to the user interface activity of operation 302, the processing device sends, by the application system, the user interface output produced by the processing device in operation 320 to the client device of operation 302. At the client device, the user interface output of operation 320 is displayed on the client device.

For example, a recommendation portion of the user interface at the client device is configured or modified based on the machine learning model output. In one example, where an instance of event data includes a profile view, a company view, a search query, or a job application, the application system uses the model output to configure a recommendation portion of the user interface output to include a recommendation to send a connection request to a particular other user of the application system. In another example, where an instance of the event data includes a user interaction with a feed or a post, the application system uses the model output to configure a recommendation portion of the user interface output to include a recommendation to follow a particular user of the application system or a particular topic in the application system.

In still another example, where the event data includes several connection invitations, the application system uses the model output to filter a connection invitation portion of the user interface output. In yet another example, where an instance of the event data includes a user interaction with a message, a profile view, a page view, or a search query, the application system uses the model output to configure a search suggestion portion of the user interface output. In another example, where an instance of the event data includes a user interaction with a feed or a notification, the application system uses the model output to configure a notification portion of the user interface output.

FIG. 4A is an example of a system 400 for data preparation in accordance with some embodiments of the present disclosure. System 400 is one embodiment of write-side portion 150A of activity feature generation system 150.

Data preparation system 402 receives and processes one or more streams of user event data 404. Data preparation system 402 also obtains attribute data 406 that corresponds to events in the streaming user event data 404. Data preparation system 402 processes and stores instances of streaming user event data 404 linked with the corresponding attribute data 406, if any, in real-time data store 256.

In an embodiment, real-time data store 256 is implemented using a distributed real-time OLAP data store such as an online, nearline, or hybrid PINOT table. A stream processing service such as SAMZA-SQL is used to process the streaming user event data 404 and the attribute data 406 for storage according to a pre-defined schema in real-time data store 256. In some embodiments, the pre-defined schema is a common schema that accommodates multiple different event types.

In some embodiments, the real-time data store 256 is implemented as a single table with the common schema, and is queried directly by application system 130 through the interface provided by activity feature generation system 150. Thus, real-time data store 256 does not store pre-computed features. Rather, real-time data store 256 stores raw event data and attribute data, and the activity features are computed on demand at read time (when requested) and provided to the machine learning model/application system through the API.

In some embodiments, streaming user event data 404 is fine-granularity user interface event tracking data, e.g., one user action event per row, and data preparation system 402 includes a SAMZA job that maps the real-time event tracking data to the appropriate schema of real-time data store 256. Data preparation system 402 performs additional processing of the raw tracking events, such as filtering of unwanted events, joins with external data stores to get attribute data, such as user profile data and/or entity attribute data, and reformatting of raw tracking events into a generalized schema, in some embodiments.

A generalized schema enables a common table to be used to store user event data derived from various tracking events. Additionally, a common schema enables the same set of data to be used for different feature generation tasks. An example of a common schema is a standardized schema that is used for representing any of multiple different types of user interface actions. For instance, a standardized schema for representing an action can be defined as:

{ “actor”: Integer,
“actorAttributes”: JsonObject,
“verb”: String,
“verbAttributes”: JsonObject,
“object”: String,
“objectAttributes”: JsonObject,
“timestamp”: Long
}

where “actor” is the ID of the user who performed the action, “actorAttributes” are attributes of the actor, “verb” is the type of action that was taken, “verbAttributes” are attributes of the verb, “object” is the entity on which the action was taken, “object Attributes” are attributes of the object, and “timestamp” is the time at which the action was taken. This standardized schema is used to represent both an online job application submission action and a click on a digital content item, such as an article in a user's feed, in some embodiments.

In some embodiments, real-time data store 256 is configured to retain data for only a short period of time, for example in the range of about 100 hours or less from the time the action is ingested. Real-time data store 256 is configured using “actor” as the primary key, in some embodiments, which facilitates quick retrieval of actions performed by a specific user of application system 130 and thus enables quick activity feature generation for that user.

In some embodiments, attribute data 406 is not stored in real-time data store 256 but is obtained at read time using a sequential join on a key-value store. That is, at read time, activity feature generation system obtains user event data 404 by querying real-time data store 256 and obtain attribute data 406 through a subsequent join.

A structured object type, e.g., maps, JSON (JavaScript object notation) types, or Tensors-based structures could be used for attribute data 406, if the implementation of real-time data store 256 supports structured objects. As another alternative, attribute data can be stored in a single column, e.g., as a string encoded as JSON.

To provide for fast data transformations, e.g., filtering or aggregation, frequently used attributes can be duplicated as columns in the real-time data store 256, to avoid the need for sequential joins at read time.

The described configuration of data preparation system 402 and use of real-time data store 256 enables features to be generated from real-time events only at read time, e.g., on demand in response to a feature request. Additionally, the described configuration enables the same event data to be reused to create similar but different features. For instance, features that differ only in their aggregation window sizes, such as the number of times a user liked any content over the last 1 hour and the number of times a user liked any content over the last 2 hours, can be generated using some of the same event data.

FIG. 4B is a flow diagram of an example method to generate a recommendation set in accordance with some embodiments of the present disclosure.

Referring to FIG. 4A, streaming user event data 404 can include, e.g., KAFKA event tracking data that tracks user interface events by a user in application system 130. Streaming user event data 404 is processed, e.g., by data preparation system 402, described above, and stored in real-time data store 256.

Real-time data store 256 supports the recording of a variety of user interface events taken by users within seconds after the occurrences of those events. Real-time data store 256 supports low-latency retrieval of either events (with user/entity attributes) or features (obtained by aggregating events) through an API such as interface 252. Interface 252 supports a get operation to fetch data for a given user as well as a batch-get operation to fetch data for a set of candidate entities, in some embodiments.

The data sizes stored in and retrieved from real-time data store 256 allow for response times of less than 100 milliseconds on a typical hardware platform for real-time data store 256.

Blocks 456, 458, 460 are performed by, e.g., read-side portion 150B of activity feature generation system 150. When a feature request is received by activity feature generation system 150, query user event data 456 queries real-time data store 256 for user event data that pertains to the received feature request. For example, if a user with user ID 999 visits an application page that contains a job recommendation module, the job recommender uses read-side portion 150B to get the attributes of all of the jobs that the user applied for online in the last 24 hours by issuing a query such as the query shown below, and then performing an aggregation operation on the retrieved job attributes to create the computed features that the job recommender needs to generate a new job recommendation for the user.

SELECT objectAttributes FROM store WHERE actor=999 AND verb=‘job-apply’ AND timestamp >(currentTime−24 hours).

In some cases, the aggregation operation is included in the query; for example by adding a GROUP BY clause to the end of the query. In other cases, attributes are joined using the result set produced by executing the query.

An instance of user event data corresponds to an action taken by a user in a user interface of application system 130, and may be referred to as an action.

An action can be represented as (user, event, entity, timestamp). Alternative terminology that may be used in some contexts includes, for user, member, actor, or viewer; for event, verb; for entity, object. For example:

(user1, viewed, job1, 123)

(user1, applied, job1, 124)

(user1, connected, user2, 125)

(user1, searched, search Query, 126)

The above example illustrates a sequence of user events that occurred in rapid succession; i.e., four events occurred in a span of less than four time increments (123 to 126), such as seconds or milliseconds. Event sequences such as the above example are captured and stored in real-time data store 256 and retrieved by query user event data 456.

Look up event attribute data 458 gets attribute data that corresponds, e.g., by a mapping of user identifier, to the result set of user event data retrieved from real-time data store 256.

Event attribute data 458 can include context data associated with an event, such as the device type used in connection with the event. A schema that includes event context can be represented as (user, event, event Attributes, entity, timestamp). For example:

(user1, applied, {device=mobile}, job1, 124)

Event attribute data 458 can include attributes of the user who issued the user interface event and the entity involved in the event.

A schema that includes user and/or entity attribute data can be represented as:

(user, user Attributes, event, event Attributes, entity, entity Attributes, timestamp).

In the above schema, the user and/or entity attributes can be {String, Float} maps or embedding vectors. An example of using {String, Float} maps as attributes is:

(user1, {industry=healthcare, geo=us}, applied, {device=mobile}, job1, {title=registered nurse, salary=100000}, 124)

An example of using embedding vectors as attributes is:

(user1, [0.1, 0.5, 0.6], applied, {device=mobile}, job1, [1.5, 0.4, 0.01], 124)

Aggregate attribute data to build features 460 executes a feature computation algorithm on the combined event-attribute data to, e.g., generate an aggregation of the attribute data such as a count, average, etc. In block 460, event data can be filtered, grouped and/or aggregated by specific dimensions to create features.

Block 460 creates activity features for a relevance model. Feature generation depends on the user and the candidate entities being scored. For example, if the user is user1 (from industry=healthcare) and one of the candidate entities being scored is job1 (with title=registered nurse), block 460 could generate one or more of the following types of features:

User Features:

number of times user1 applied to any job over the last 1 hour;

number of times user1 applied to any job over the last 6 hours;

average embedding vector of all jobs that user1 applied to over the last 1 hour.

(User, Entity) Pair Features:

number of times user1 applied to a job with title=registered nurse over the last 1 hour;

number of times job1 was applied to by users in industry=healthcare over the last 1 hour.

Examples of transformations (e.g., aggregations or derivations) that can be performed at block 460 include:

Sum/Count (e.g., a count of the number of times a user applied to jobs of a certain title);

Avg (e.g., the average salary of the jobs a user applied to);

Latest (e.g., the title of the most recent job that a user applied to); and

Avg Pooling (e.g., assuming each job can be embedded to some low dimensional vector, average those vectors together); and

Sequence Models: use machine learning model architectures to predict the next sequence item from an input sequence of events and event attributes. For example, sequence models are often trained on next item prediction for recommender systems. Using the disclosed approaches to train sequence models that optimize for next item prediction can result in models that can produce representation learning features (e.g., sequence embeddings) that can be highly predictive features for a recommender system.

Blocks 462, 464, 466 are performed by application system 130, in some embodiments. More specifically, blocks 462 and 466 are performed by a recommender component 218 and block 464 is performed by a machine learning model 204, in some embodiments. Get initial recommendation set 462 is performed by a recommender component 218 and includes any process for generating an initial recommendation set without or prior to receiving model output provided by machine learning model 204. For example, an initial recommendation set could include an unsorted list of content items or an unranked list of job candidates or an unranked list of connection candidates.

Apply machine learning model 464 is triggered by a request for model output from a recommender component. In turn, apply machine learning model 464 triggers blocks 456, 458, 460 to be performed by activity feature generation system 150. Apply machine learning model 464 consumes the activity features produced by block 460 and provides the resulting model output to the recommender component. Recommender component generates a modified recommendation set based on the model output produced at block 464, and presents the modified recommendation set at a user interface of a client device at block 466.

The on-demand computation of features enables the machine learning model output, and resulting recommendations to be adapted in real time. The following are some examples of how the on-demand user activity features can benefit various recommenders.

Job recommendations: job searches, views, and applications by a user in the recent past can be used to infer short-term job preferences of the user and adapt jobs you may be interested in recommendations to the user's short-term preferences.

Connection recommendations: profiles viewed, companies viewed, search queries, jobs applied to by a user in the recent past can be used to infer short-term networking preferences of the user and adapt people you may be interested in recommendations to the user's short-term preferences.

Follow recommendations: feed interactions (e.g., root actors, hashtags in feed updates) and feed posts (hashtags in posts) from a user in the recent past can be used to infer short-term follow preferences of the user and adapt follow recommendations to the user's short-term preferences.

Anti-abuse: unconventional actions (such as sending a series of invites to women) by a user in the recent past can be used to quickly identify abusers and other policy violations.

Job searches, job views, job applications, company searches, company views, feed interactions (along with content of those) by a user in the recent past can be used to target digital content items based on the user's recent interactions.

Search: messages, profile views, page views, search queries by a user in the recent past can be used to infer what the user is looking for and adapt search typeahead suggestions and results based on the user's recent activity.

Notifications: feed interactions, notification interactions by a user in the recent past can be used to infer short-term intent and preferences of the viewer and adapt near-line notifications based on the user's short-term intent and preferences.

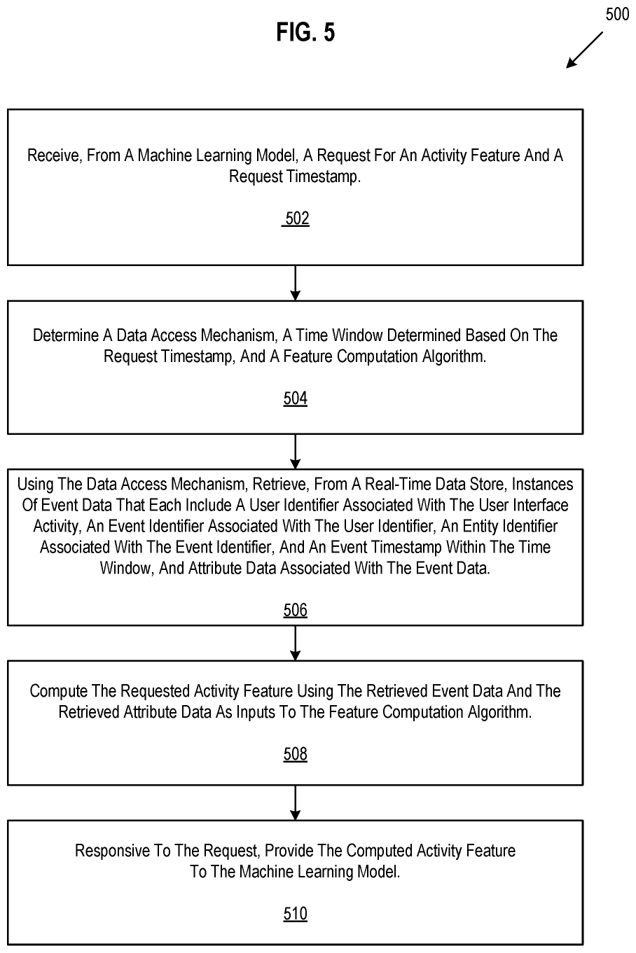

FIG. 5 is a flow diagram of an example method to compute a feature for a machine learning model in accordance with some embodiments of the present disclosure.

The method 500 is performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, portions of the method 500 are performed by the application system 130 and/or the activity feature generation system 150 of FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 502, the processing device receives, from a machine learning model associated with a user interface activity by an application system that uses output of the machine learning model to configure a downstream operation responsive to the user interface activity, a request for an activity feature and a request timestamp. Operation 502 is performed, for example, by interface 252 of activity feature generation system 150, described above.

At operation 504, the processing device reads a feature configuration associated with the machine learning model. The processing device determines, using the feature configuration, a data access mechanism, a time window determined based on the request timestamp, and a feature computation algorithm. Operation 504 is performed, for example, by interface 252 of activity feature generation system 150 using feature configuration 254, described above.

The data access mechanism includes a query in a format that can be executed against the real-time data store, in some embodiments. The data access mechanism also includes a location of the real-time data store, in some embodiments. A maximum value of the time window can be defined as N time increments (e.g., N days, hours, minutes, seconds, milliseconds) prior to and including the request timestamp. N can be a positive number. For example, a time window can be N days prior to the day of the request, such as the preceding 5 days. A difference between the request timestamp and a timestamp at which the computed activity feature is provided to the machine learning model is less than about 100 milliseconds, in some embodiments.

At operation 506, the processing device retrieves, using the data access mechanism, from a real-time data store, instances of event data that each comprise a user identifier associated with the user interface activity of operation 502, an event identifier associated with the user identifier, an entity identifier associated with the event identifier, an event timestamp within the time window, and attribute data associated with the instance of event data. Operation 506 is performed, for example, by interface 252 of activity feature generation system 150 using data access mechanism 258 and real-time data store 256, described above.

The instances of event data are obtained by querying the real-time data store. The real-time data store is arranged according to a schema that is based on a feature type associated with the request, in some embodiments. The attribute data is obtained by performing a sequential lookup on a key-value store using the entity identifier as a key, in some embodiments.

At operation 508, the processing device computes a user activity feature using the retrieved event data and the retrieved attribute data as inputs to the feature computation algorithm. The user activity feature is computed by performing one or more of an aggregation, a filtering, or a grouping, of the attribute data, for example. Performing an aggregation includes computing, over the time window, a sum, a count, an average, a date comparison, an average pooling, a histogram, or a probability distribution, on the attribute data, in some embodiments. Performing a filtering includes removing instances of event data that have a null value in the user ID filed, in some embodiments. Performing a grouping includes grouping event data based on a common value of a particular attribute, such as geographic location, in some embodiments.

Computing the user activity feature includes applying the feature computation algorithm to instances of event data that match a user identifier associated with the user interface activity, in some embodiments. Computing the user activity feature includes applying the feature computation algorithm to instances of event data that match an event identifier associated with the user interface activity, in some embodiments. Computing the user activity feature includes applying the feature computation algorithm to instances of event data that match a value of an attribute of an event associated with the user interface activity or an entity associated with the user interface activity, in some embodiments.

Operation 508 can be performed, for example, by interface 252 of activity feature generation system 150 using data access mechanism 258, real-time data store 256, and feature computation algorithm 260, as described above.

At operation 510, the processing device, responsive to the request, provides the computed user activity feature to the machine learning model. Operation 510 can be performed, for example, by interface 252 of activity feature generation system 150, as described above.

FIG. 6 illustrates an example machine of a computer system 600 within which a set of instructions for causing the machine to perform any one or more of the methodologies discussed herein are executed. In some embodiments, the computer system 600 corresponds to a component of a networked computer system (e.g., the computer system 100 of FIG. 1) that includes, is coupled to, or utilizes a machine to execute an operating system to perform operations corresponding to the activity feature generation system 150 of FIG. 1.

The machine is connected (e.g., networked) to other machines in a local area network (LAN), an intranet, an extranet, and/or the Internet, in some embodiments. The machine operates in the capacity of a server or a client machine in a client-server network environment, as a peer machine in a peer-to-peer (or distributed) network environment, or as a server or a client machine in a cloud computing infrastructure or environment, in various embodiments.

The machine is a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a memory 606 (e.g., flash memory, static random-access memory (SRAM), etc.), an input/output system 610, and a data storage system 640, which communicate with each other via a bus 630.

The main memory 604 is configured to store instructions 614 for performing the operations and steps discussed herein. Instructions 614 include portions of activity feature generation system 150 when those portions of activity feature generation system 150 are stored in main memory 604. Thus, activity feature generation system 150 is shown in dashed lines as part of instructions 614 to illustrate that portions of activity feature generation system 150 can be stored in main memory 604. However, it is not required that activity feature generation system 150 be embodied entirely in instructions 614 at any given time and portions of activity feature generation system 150 can be stored in other components of computer system 600.

Processing device 602 represents one or more general-purpose processing devices such as a microprocessor, a central processing unit, or the like. Processing device 602 is a complex instruction set computing (CISC) microprocessor, reduced instruction set computing (RISC) microprocessor, very long instruction word (VLIW) microprocessor, or a processor implementing other instruction sets, or processors implementing a combination of instruction sets, in some embodiments. Alternatively, processing device 602 is one or more special-purpose processing devices such as an application specific integrated circuit (ASIC), a field programmable gate array (FPGA), a digital signal processor (DSP), network processor, or the like. The processing device 602 is configured to execute instructions 612 for performing the operations and steps discussed herein.

Instructions 612 include portions of activity feature generation system 150 when those portions of activity feature generation system 150 are being executed by processing device 602. Thus, similar to the description above, activity feature generation system 150 is shown in dashed lines as part of instructions 612 to illustrate that, at times, portions of activity feature generation system 150 are executed by processing device 602. For example, when at least some portion of activity feature generation system 150 is embodied in instructions to cause processing device 602 to perform the method(s) described above, some of those instructions can be read into processing device 602 (e.g., into an internal cache or other memory) from main memory 604 and/or data storage system 640. However, it is not required that all of activity feature generation system 150 be included in instructions 612 at the same time and portions of activity feature generation system 150 are stored in one or more other components of computer system 600 at other times, e.g., when one or more portions of activity feature generation system 150 are not being executed by processing device 602.

The computer system 600 can further include a network interface device 608 to communicate over the network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation network interface device 608 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 600.

Computer system 600 can send messages and receive data, including program code, through the network(s) and network interface device 608. In the Internet example, a server can transmit a requested code for an application program through the Internet 628 and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 at different times during execution thereof by the computer system 600, the main memory 604 and the processing device 602 also constituting machine-readable storage media.

In one embodiment, the instructions 644 include instructions to implement functionality corresponding to a feature generation component (e.g., the activity feature generation system 150 of FIG. 1). Activity feature generation system 150 is shown in dashed lines as part of instructions 644 to illustrate that, similar to the description above, portions of activity feature generation system 150 can be stored in data storage system 640 alternatively or in addition to being stored within other components of computer system 600.

Dashed lines are used in FIG. 6 to indicate that it is not required that activity feature generation system 150 be embodied entirely in instructions 612, 614, and 644 at the same time. In one example, portions of activity feature generation system 150 are embodied in instructions 644, which are read into main memory 604 as instructions 614, and portions of instructions 614 are read into processing device 602 as instructions 612 for execution. In another example, some portions of activity feature generation system 150 are embodied in instructions 644 while other portions are embodied in instructions 614 and still other portions are embodied in instructions 612.

While the machine-readable storage medium 642 is shown in an example embodiment to be a single medium, the term “machine-readable storage medium” should be taken to include a single medium or multiple media that store the one or more sets of instructions. The term “machine-readable storage medium” includes any medium that is capable of storing or encoding a set of instructions for execution by the machine and that cause the machine to perform any one or more of the methodologies of the present disclosure. The term “machine-readable storage medium” includes, but is not limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented methods and processes and implement the systems described above in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In an example 1, a network-based service including a computing device that executes an application to: receive, from a machine learning model associated with a user interface activity by an application system, a request for a user activity feature and a request timestamp; using a feature configuration associated with the requested user activity feature, determine a data access mechanism, a time window determined based on the request timestamp, and a feature computation algorithm; using the data access mechanism, retrieve, from a real-time data store, a plurality of instances of event data that each include: a user identifier associated with the user interface activity, an event identifier associated with the user identifier, an entity identifier associated with the event identifier, an event timestamp within the time window, and attribute data associated with the instance of event data; compute the requested user activity feature using the retrieved plurality of instances of event data and the retrieved attribute data as inputs to the feature computation algorithm; and responsive to the request, provide the computed user activity feature to the machine learning model. Example 1 also includes an interface hosted on the computing device, that can be invoked by the machine learning model to send the request to the application and to receive the computed user activity feature from the application.

An example 2 includes the subject matter of example 1, where the computing device computes the user activity feature by performing one or more of an aggregation, a filtering, or a grouping, of the attribute data. An example 3 includes the subject matter of example 2, where performing the aggregation includes computing, over the time window, one of a sum, a count, an average, a date comparison, an average pooling, a histogram, or a probability distribution, on the attribute data. An example 4 includes the subject matter of any of examples 1-3, where the computing device executes the application to obtain the plurality of instances of event data by querying the real-time data store. An example 5 includes the subject matter of example 4, where the real-time data store is arranged according to a schema that is defined based on a feature type associated with the request. An example 6 includes the subject matter of any of examples 1-5, where the computing device executes the application to obtain the attribute data by performing a sequential lookup on a key-value store using the entity identifier as a key. An example 7 includes the subject matter of any of examples 1-6, where a maximum value of the time window is defined as N days prior to and including a day of the request timestamp, and N is a positive integer. An example 8 includes the subject matter of any of examples 1-7, where a difference between the request timestamp and a timestamp at which the user activity feature is computed is less than 100 milliseconds. An example 9 includes the subject matter of any of examples 1-8, where the data access mechanism includes a query in a format that can be executed against the real-time data store and a location of the real-time data store.

In an example 10, a method includes receiving, at an application system that uses output of a machine learning model to configure a user interface in response to user activity, from a client device, data that indicates a user interface activity in the application system; sending, by the application system, to the machine learning model, a request for model output; sending, by the machine learning model, a request for a user activity feature and a request timestamp to a feature generation system; reading, by the feature generation system, a feature configuration associated with the requested user activity feature; determining, by the feature generation system, based on the feature configuration, a data access mechanism for a real-time data store, a time window defined by the request timestamp, and a feature computation algorithm; retrieving, from the real-time data store, by the feature generation system using the data access mechanism, a plurality of instances of event data that each include: a user identifier associated with the user interface activity, an event identifier associated with the user identifier, an entity identifier associated with the event identifier, an event timestamp within the time window, and attribute data associated with the plurality of instances of event data; computing, by the feature generation system, the requested user activity feature using the plurality of instances of event data and the attribute data as inputs to the feature computation algorithm; responsive to the feature request, by the feature generation system, providing the computed user activity feature to the machine learning model; responsive to the request for model output, by the machine learning model, generating a model output using the computed user activity feature as an input, and providing the model output to the application system; generating, by the application system, user interface output based on the model output; responsive to the user interface activity, by the application system, sending the user interface output to the client device.

An example 11 includes the subject matter of example 10, where an instance of the plurality of instances of event data includes one of a job search, a job view, a job application, or a job dismiss, and the application system uses the model output to configure a recommendation portion of the user interface output to include a recommendation to submit a job application for a particular job. An example 12 includes the subject matter of example 10 or example 11, where an instance of the plurality of instances of event data includes one of a profile view, a company view, a search query, or a job application, and the application system uses the model output to configure a recommendation portion of the user interface output to include a recommendation to send a connection request to a particular other user of the application system. An example 13 includes the subject matter of any of examples 10-12, where an instance of the plurality of instances of event data includes a user interaction with one of a feed or a post, the application system uses the model output to configure a recommendation portion of the user interface output to include a recommendation to follow one of a particular user of the application system or a particular topic in the application system. An example 14 includes the subject matter of any of examples 10-13, where the plurality of instances of event data each include a connection invitation, and the application system uses the model output to filter a connection invitation portion of the user interface output. An example 15 includes the subject matter of any of examples 10-14, where an instance of the plurality of instances of event data includes one of a user interaction with a message, a profile view, a page view, or a search query, and the application system uses the model output to configure a search suggestion portion of the user interface output. An example 16 includes the subject matter of any of examples 10-15, where an instance of the plurality of instances of event data includes a user interaction with one of a feed or a notification, and the application system uses the model output to configure a notification portion of the user interface output.

In an example 17, a method includes receiving, from an application system that uses output of a machine learning model to respond to a user interface activity in the application system, a request for model output; sending, by the machine learning model, a feature request, and a request timestamp to a feature generation system; reading, by the feature generation system, a feature configuration associated with a requested user activity feature; determining, by the feature generation system, based on the feature configuration, a data access mechanism for a real-time data store, a time window defined by the request timestamp, and a feature computation algorithm; retrieving, from the real-time data store, by the feature generation system using the data access mechanism, a plurality of instances of event data that each include an event timestamp within the time window, and attribute data associated with the plurality of instances of event data; computing, by the feature generation system, the requested user activity feature using the plurality of instances of event data and the attribute data as inputs to the feature computation algorithm; responsive to the feature request, providing, by the feature generation system, the computed user activity feature to the machine learning model; responsive to the request for model output, by the machine learning model, generating a model output using the computed user activity feature as an input, and providing the model output to the application system.

An example 18 includes the subject matter of example 17, where computing the requested user activity feature includes applying the feature computation algorithm to a portion of the plurality of instances of event data that matches a user identifier associated with the user interface activity. An example 19 includes the subject matter of example 17 or example 18, where computing the requested user activity feature includes applying the feature computation algorithm to a portion of the plurality of instances of event data that matches an event identifier associated with the user interface activity. An example 20 includes the subject matter of any of examples 17-20, where computing the requested user activity feature includes applying the feature computation algorithm to a portion of the plurality of instances of event data that matches a value of an attribute of one of an event associated with the user interface activity or an entity associated with the user interface activity.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A network-based service comprising:
a computing device that executes an application to:
(i) receive, from a machine learning model associated with a user interface activity by an application system, a request for a user activity feature and a request timestamp;
(ii) using a feature configuration associated with the requested user activity feature, determine a data access mechanism, a time window determined based on the request timestamp, and a feature computation algorithm;
(iii) using the data access mechanism, retrieve, from a real-time data store, a plurality of instances of event data that each comprise: a user identifier associated with the user interface activity, an event identifier associated with the user identifier, an entity identifier associated with the event identifier, an event timestamp within the time window, and attribute data associated with the instance of event data;
(iv) compute the requested user activity feature using the retrieved plurality of instances of event data and the retrieved attribute data as inputs to the feature computation algorithm; and
(v) responsive to the request, provide the computed user activity feature to the machine learning model; and
an interface hosted on the computing device, that can be invoked by the machine learning model to send the request to the application and to receive the computed user activity feature from the application.

2. The network-based service of claim 1, wherein the computing device computes the user activity feature by performing one or more of an aggregation, a filtering, or a grouping, of the attribute data.

3. The network-based service of claim 2, wherein performing the aggregation comprises computing, over the time window, one of a sum, a count, an average, a date comparison, an average pooling, a histogram, or a probability distribution, on the attribute data.

4. The network-based service of claim 1, wherein the computing device executes the application to obtain the plurality of instances of event data by querying the real-time data store.

5. The network-based service of claim 4, wherein the real-time data store is arranged according to a schema that is defined based on a feature type associated with the request.

6. The network-based service of claim 1, wherein the computing device executes the application to obtain the attribute data by performing a sequential lookup on a key-value store using the entity identifier as a key.

7. The network-based service of claim 1, wherein a maximum value of the time window is defined as N days prior to and including a day of the request timestamp, and N is a positive integer.

8. The network-based service of claim 1, wherein a difference between the request timestamp and a timestamp at which the user activity feature is computed is less than 100 milliseconds.

9. The network-based service of claim 1, wherein the data access mechanism comprises a query in a format that can be executed against the real-time data store and a location of the real-time data store.

10. A method comprising:
receiving, at an application system that uses output of a machine learning model to configure a user interface in response to user activity, from a client device, data that indicates a user interface activity in the application system;
sending, by the application system, to the machine learning model, a request for model output;
sending, by the machine learning model, a request for a user activity feature and a request timestamp to a feature generation system;
reading, by the feature generation system, a feature configuration associated with the requested user activity feature;
determining, by the feature generation system, based on the feature configuration, a data access mechanism for a real-time data store, a time window defined by the request timestamp, and a feature computation algorithm;
retrieving, from the real-time data store, by the feature generation system using the data access mechanism, a plurality of instances of event data that each comprise: a user identifier associated with the user interface activity, an event identifier associated with the user identifier, an entity identifier associated with the event identifier, an event timestamp within the time window, and attribute data associated with the plurality of instances of event data;
computing, by the feature generation system, the requested user activity feature using the plurality of instances of event data and the attribute data as inputs to the feature computation algorithm;
responsive to the feature request, by the feature generation system, providing the computed user activity feature to the machine learning model;
responsive to the request for model output, by the machine learning model, generating a model output using the computed user activity feature as an input, and providing the model output to the application system;
generating, by the application system, user interface output based on the model output; and
responsive to the user interface activity, by the application system, sending the user interface output to the client device.

11. The method of claim 10, wherein an instance of the plurality of instances of event data comprises one of a job search, a job view, a job application, or a job dismiss, and the application system uses the model output to configure a recommendation portion of the user interface output to include a recommendation to submit a job application for a particular job.

12. The method of claim 10, wherein an instance of the plurality of instances of event data comprises one of a profile view, a company view, a search query, or a job application, and the application system uses the model output to configure a recommendation portion of the user interface output to include a recommendation to send a connection request to a particular other user of the application system.

13. The method of claim 10, wherein an instance of the plurality of instances of event data comprises a user interaction with one of a feed or a post, the application system uses the model output to configure a recommendation portion of the user interface output to include a recommendation to follow one of a particular user of the application system or a particular topic in the application system.

14. The method of claim 10, wherein the plurality of instances of event data each comprise a connection invitation, and the application system uses the model output to filter a connection invitation portion of the user interface output.

15. The method of claim 10, wherein an instance of the plurality of instances of event data comprises one of a user interaction with a message, a profile view, a page view, or a search query, and the application system uses the model output to configure a search suggestion portion of the user interface output.

16. The method of claim 10, wherein an instance of the plurality of instances of event data comprises a user interaction with one of a feed or a notification, and the application system uses the model output to configure a notification portion of the user interface output.

17. A method comprising:
receiving, from an application system that uses output of a machine learning model to respond to a user interface activity in the application system, a request for model output;
sending, by the machine learning model, a feature request, and a request timestamp to a feature generation system;
reading, by the feature generation system, a feature configuration associated with a requested user activity feature;
determining, by the feature generation system, based on the feature configuration, a data access mechanism for a real-time data store, a time window defined by the request timestamp, and a feature computation algorithm;
retrieving, from the real-time data store, by the feature generation system using the data access mechanism, a plurality of instances of event data that each comprise an event timestamp within the time window, and attribute data associated with the plurality of instances of event data;
computing, by the feature generation system, the requested user activity feature using the plurality of instances of event data and the attribute data as inputs to the feature computation algorithm;
responsive to the feature request, providing, by the feature generation system, the computed user activity feature to the machine learning model; and
responsive to the request for model output, by the machine learning model, generating a model output using the computed user activity feature as an input, and providing the model output to the application system.

18. The method of claim 17, wherein computing the requested user activity feature comprises applying the feature computation algorithm to a portion of the plurality of instances of event data that matches a user identifier associated with the user interface activity.

19. The method of claim 17, wherein computing the requested user activity feature comprises applying the feature computation algorithm to a portion of the plurality of instances of event data that matches an event identifier associated with the user interface activity.

20. The method of claim 17, wherein computing the requested user activity feature comprises applying the feature computation algorithm to a portion of the plurality of instances of event data that matches a value of an attribute of one of an event associated with the user interface activity or an entity associated with the user interface activity.
